(19) United States
(12) Patent Application Publication
(10) Pub. No.: US 2012/0130518 A1
(43) Pub. Date: May 24, 2012

(54) MUSIC DATA REPRODUCTION APPARATUS

(75) Inventors: Fumihiko Aoyama, Iwaki (JP); Koichi Uno, Iwaki (JP)

(73) Assignee: Alpine Electronics, Inc., Tokyo (JP)

(21) Appl. No.: 13/204,867

(22) Filed: Aug. 8, 2011

(30) Foreign Application Priority Data
Nov. 19, 2010 (JP) 2010-259056

(51) Int. Cl. G06F 17/00

(52) U.S. Cl. 700/94

(57) ABSTRACT

A music data reproduction apparatus can reproduce music data stored in a hierarchical folder with a simpler operation, and the reproduction can be started in a shorter time. An audio system for reproducing music data stored in a hierarchical format in one or more folders recorded on a memory includes a folder specifying unit for specifying one of the folders, a music data extracting unit for extracting music data stored in a lower-level folder under the folder that is specified by the folder specifying unit, and an audio processing unit for reproducing the music data that is extracted by the music data extracting unit.

### BACKGROUND OF THE INVENTION

1. Related Application

The present application claims priority to Japanese Patent Application Number 2010-259056, filed Nov. 19, 2010, the entirety of which is hereby incorporated by reference.

2. Field of the Invention

The present invention relates to a music data reproduction apparatus for retrieving and reproducing music data having a hierarchical folder structure.

3. Related Art

There has conventionally been known a data reproduction apparatus in which music data stored in hierarchical folders is recorded on a storage medium and, when a folder is specified among the folders displayed, the music data included in the folder is generated (see pages 3 to 8 and FIGS. 1 to 8 of JP2007-250036A, for example). This data reproduction apparatus is arranged such that folders with no reproducible music data stored therein are displayed in a manner distinguishable from other folders with music data stored therein and that, upon specifying a folder, folders with no music data are skipped, so that the time required to search for data is not increased needlessly.

Meanwhile, the foregoing data reproduction apparatus disclosed in JP2007-250036A, in which folders with no music data cannot be specified, suffers from a problem in that the operation of specifying a folder with music data stored therein and actually identifying and reproducing the music data is cumbersome and takes time. If the apparatus has a multi-hierarchical folder structure and music data is stored in one of the lowest-level folders, it is necessary to specify folders sequentially from higher to lower levels and finally identify and reproduce music data in the lowest level. This requires a large number of operations to identify the music data, and accordingly takes some time to start reproduction.

### SUMMARY

The present invention has been made in view of these problems, and an object thereof is to provide a music data reproduction apparatus in which music data stored in a hierarchical folder can be reproduced with a simpler operation, and the reproduction can be started in a shorter time.

In order to solve the above-described problems, one embodiment of the present invention provides a music data reproduction apparatus for reproducing music data stored in a hierarchical format in one or more folders recorded on a storage medium, the apparatus including: folder specifying means for specifying one of the folders; music data extracting means for extracting music data stored in a lower-level folder under the folder that is specified by the folder specifying means; and reproducing means for reproducing the music data that is extracted by the music data extracting means.

When one of the folders is specified, music data stored in a lower-level folder under the specified folder is extracted and reproduced. This avoids the need to identify a lower-level folder to search for the music data, whereby music data stored in a hierarchical folder can be reproduced with a simpler operation, and the reproduction can be started in a shorter time.

It is preferred that the music data extracting means be configured to extract music data stored in the folder that is specified by the folder specifying means and music data stored in a lower-level folder under the specified folder, and that the reproducing means be configured to reproduce the music data that is extracted by the music data extracting means. This requires only one folder to be specified to extract and reproduce all of the music data stored in the folder without performing a separate operation for the folder structure under the folder. This considerably simplifies the reproducing operation.

It is preferred that the apparatus further include display means for displaying a selection screen including folders and files of the same level; and operating means for selecting one of the folders and files of the same level included in the selection screen that is displayed on the display means, and that the folder specifying means be configured, when one of the folders is selected by the operating means, to specify the selected folder. This requires only one of the displayed folders to be selected to extract and reproduce music data stored in a lower-level folder under the selected folder without performing any additional operation.

It is preferred that the selection screen include: a first area on which one of the displayed folders is selected and an order for reproducing music data stored in the selected folder and a lower-level folder thereunder is provided; and a second area on which an order for switching display to the selection screen that includes the music data stored in the selected folder and the lower-level folder thereunder is provided, and that the display means be configured, when the second area is selected by the operating means, to display the selection screen that includes music data stored in the corresponding folder and a next-lower-level folder thereunder. This allows an operation of extracting and reproducing music data stored in a lower-level folder under the displayed folders without any additional operation or a traditional operation of specifying a folder and searching lower-level folders thereunder for music data to be performed selectively, which can improve the operability according to a user's preference.

It is preferred that the apparatus further include: a microphone for collecting the voice of the user; and voice recognizing means for recognizing the voice collected by the microphone, and that the folder specifying means be configured to specify a folder based on a content identified through voice recognition by the voice recognizing means. It is particularly preferred that when a folder name is read by the user, the name be identified through voice recognition by the voice recognizing means, and that the folder specifying means specify a folder that corresponds to the identified name. This can simplify an audible operation through voice recognition, if performed, and achieve significant time saving compared to the case of audibly specifying a folder in each hierarchical level to specify music data stored in a lower-level folder.

It is preferred that the apparatus further include dictionary preparing means for extracting the names of the hierarchical folders recorded on the storage medium and files representing music data stored in the folders to prepare a voice recognition dictionary including the names, and that the voice recognizing means be configured to perform voice recognition using the voice recognition dictionary prepared by the dictionary preparing unit. This allows the names of the folders and files that are to undergo voice recognition to be limited, and thus the accuracy of the voice recognition to be improved, as well as the time required for the voice recognition to be reduced.

It is preferred that the storage medium be removably connected, and that the dictionary preparing means be configured to prepare the voice recognition dictionary when the storage medium is connected. A voice recognition dictionary of a size required for voice recognition is prepared each time the storage medium is connected, which allows the capacity for storing the voice recognition dictionary to be reduced.

It is preferred that the reproducing means be configured, when the reproduction of a plurality of pieces of music data comes full circle, to continue reproducing the music data from the initially reproduced music data. This allows for continuous music reproduction with no additional operation when the present invention is applied to car audio systems.

### BRIEF DESCRIPTION OF THE DRAWINGS

FIG. 1 illustrates the configuration of an audio system according to a preferred embodiment;

FIG. 2 illustrates a specific example of a hierarchical folder structure;

FIG. 3 illustrates a specific example of an ID assigned to each folder and file;

FIG. 4 is a flow chart illustrating an operational procedure of music reproduction using a selection screen;

FIG. 5 illustrates a specific example of the selection screen;

FIG. 6 illustrates a display example of an error screen;

FIG. 7 is a flow chart illustrating an operational procedure of preparing a voice recognition dictionary; and

FIG. 8 is a flow chart illustrating an operational procedure of music reproduction through voice recognition.

### DETAILED DESCRIPTION OF PREFERRED EMBODIMENT

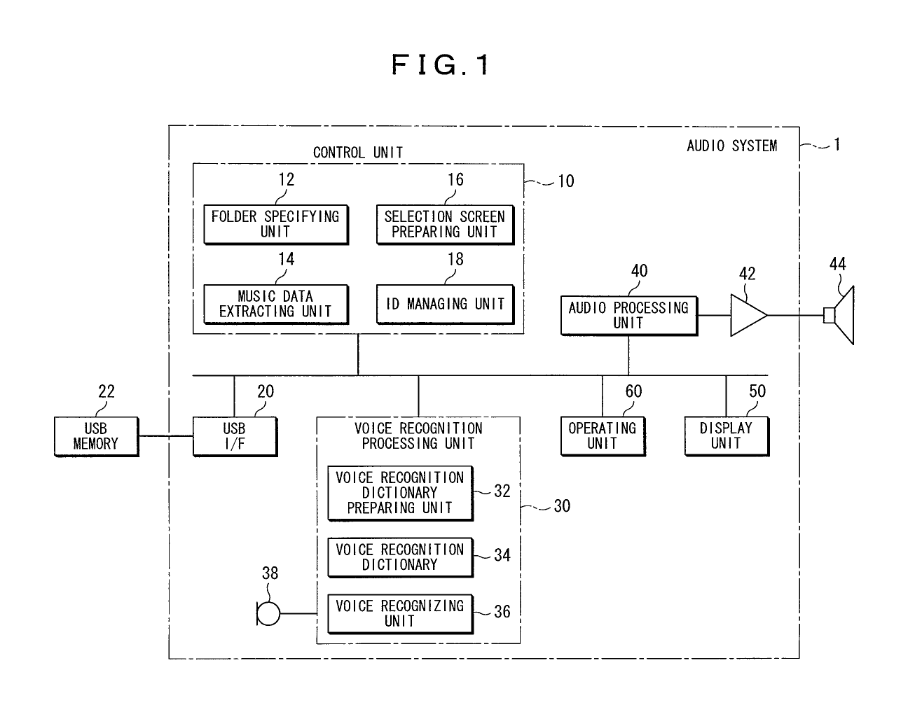

An audio system according to a preferred embodiment to which a music data reproduction apparatus according to the present invention is applied will hereinafter be described in detail with reference to the accompanying drawings. FIG. 1 illustrates the general configuration of the audio system according to this preferred embodiment. The audio system may be installed in a vehicle, for example.

Referring to FIG. 1, the audio system 1 includes a control unit 10, a USB (Universal Serial Bus) interface unit (USB I/F) 20, a voice recognition processing unit 30, a microphone 38, an audio processing unit 40, an amplifier 42, a display unit 50, and an operating unit 60.

The control unit 10 is configured to control the entire audio system 1. The control unit 10 will be described in more detail hereinafter. The USB interface unit 20 is configured to control signal input/output to/from a USB memory 22 serving as an external storage medium, the unit including a USB port and a USB host controller. Music data is recorded on the USB memory 22 using hierarchical folders. For example, users can arbitrarily structure the multiple hierarchical folders and specify one of the folders to store desired music data therein.

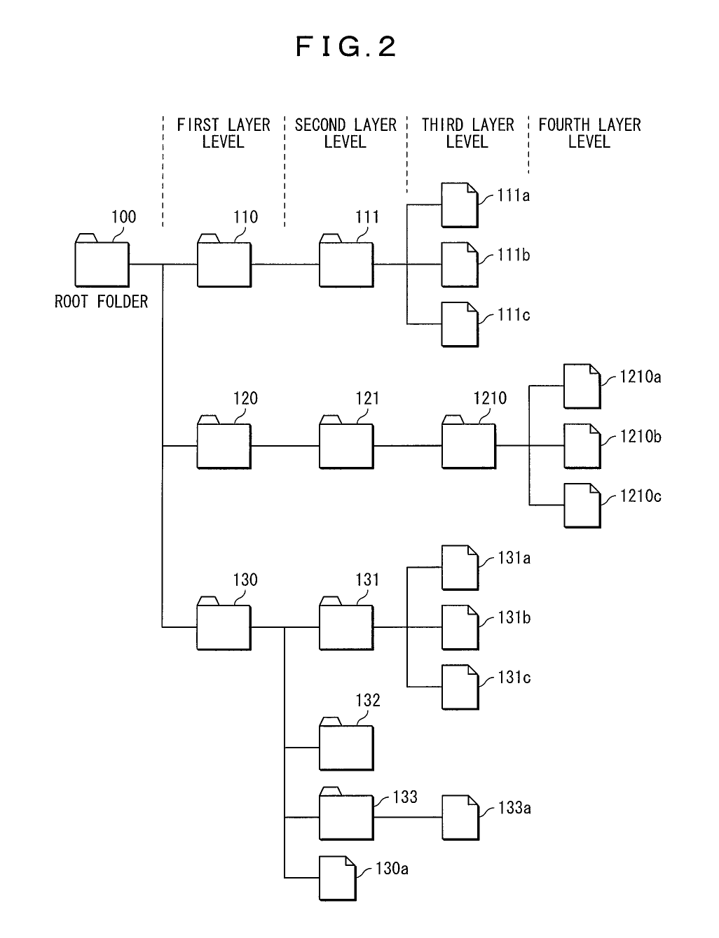

FIG. 2 illustrates a specific example of a hierarchical folder structure. In the example of FIG. 2, three first-layer-level folders 110, 120, and 130 exist under a root folder 100. Under the folder 110 exists a second-layer-level folder 111. In the folder 111 are stored three music data files 111a, 111b, and 111c. Under the folder 120 exists a second-layer-level folder 121 and, thereunder, a third-layer-level folder 1210. In the folder 1210 are stored three music data files 1210a, 1210b, and 1210c. Under the folder 130 exist three second-layer-level folders 131, 132, and 133 and a music data file 130a. In the folder 131 are stored three music data files 131a, 131b, and 131c. In the folder 133 is stored a music data file 133a. It should be noted that music data of different formats may exist in a mixed manner as long as they are reproducible in the audio system 1 according to this preferred embodiment.

The voice recognition processing unit 30 is configured to perform voice recognition processing on a user's voice collected through the microphone 38, the unit including a voice recognition dictionary preparing unit 32, a voice recognition dictionary 34, and a voice recognizing unit 36. The voice recognition dictionary preparing unit 32 is configured to prepare the voice recognition dictionary 34 including the names of the folders recorded on the USB memory 22 and the music data files stored in the folders. The voice recognition dictionary 34, which is usually prepared when the USB memory 22 is connected to the audio system 1 (i.e., inserted into the USB port), may be prepared according to an instruction from a user.

The voice recognizing unit 36 is configured to perform voice recognition processing on a user's voice collected through the microphone 38 using the prepared voice recognition dictionary 34 and identify a folder or a file specified by the user.

The audio processing unit 40 is configured to reproduce music data read out of the USB memory 22 by the control unit 10, that is, to perform decode processing for each data format to output an audio signal. The audio signal is to be amplified by the amplifier 42 and output from a speaker 44. It should be noted that, although audio signals are to be actually reproduced and output through two or more channels, only one amplifier 42 and speaker 44 are shown in the example of FIG. 1 for the sake of simplicity.

The display unit 50 is configured to display reproduction details (song title, artist name, reproduction-elapsed time, and other information) of music data and a selection screen on which users specify music data to reproduce.

The operating unit 60 is configured to receive an instruction from a user for starting/stopping reproduction and/or setting volume and audio quality, the unit including various switches and operating knobs. In this preferred embodiment, at the time the selection screen is displayed on the display unit 50, if the user points his/her finger directly at a folder name or file name included in the selection screen, the user can provide an instruction for identifying the folder or file and reproducing the identified file or a file stored in the identified folder or a lower-level folder thereunder. For such operations through the selection screen, the operating unit 60 is provided with a touch panel for detecting the position of a pointed finger. It should be noted that, instead of using a touch panel, a remote control unit or the like may be used to select a part of the selection screen according to an instruction from a user.

The control unit 10 will next be described. As shown in FIG. 1, the control unit 10 includes a folder specifying unit 12, a music data extracting unit 14, a selection screen preparing unit 16, and an ID managing unit 18. The folder specifying unit 12 is configured to specify one of the folders and files included in the USB memory 22 by using the operating unit 60 to select any of one or more folders and files that are included in the selection screen displayed on the display unit 50 or by identifying a folder or file based on a user's speech content identified through voice recognition by the voice recognition processing unit 30 (specifically by identifying a folder or file corresponding to a spoken folder name or file name).

The music data extracting unit 14 is configured, when a folder is specified by the folder specifying unit 12, to search for a file stored in the specified folder or a lower-level folder thereunder to extract music data from the file.

The selection screen preparing unit 16 is configured to prepare a selection screen used to specify a folder using the operating unit 60. The selection screen is to be displayed on the display unit 50. The ID managing unit 18 is configured to assign an ID according to the folder structure to each folder and file recorded on the USB memory 22.

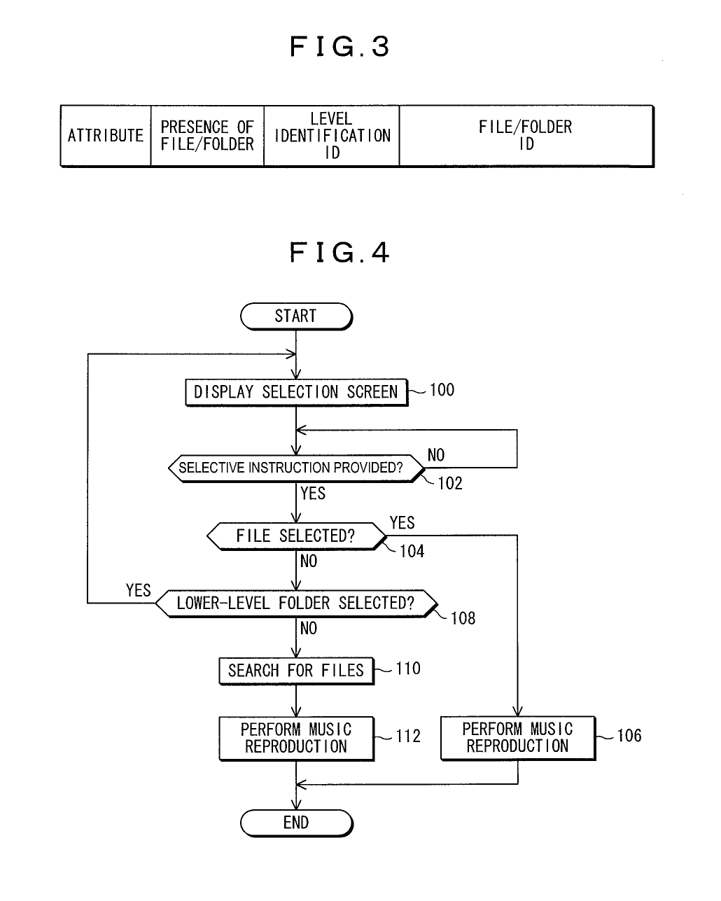

FIG. 3 illustrates a specific example of an ID assigned to each folder and file. As shown in FIG. 3, the ID includes “attribute”, “presence of file/folder”, “level identification ID”, and “file/folder ID”. “Attribute” indicates whether the ID is assigned to a file or a folder. “Presence of file/folder” indicates, if the ID is assigned to a folder, whether or not a file or lower-level folder exists under the folder. “Level identification ID” indicates the level of the file or folder to which the ID is assigned. “File/folder ID” indicates an identifier corresponding to the file or folder.

The above-described folder specifying unit 12, music data extracting unit 14, audio processing unit 40, display unit 50, operating unit 60, voice recognizing unit 36, and voice recognition dictionary preparing unit 32 correspond, respectively, to folder specifying means, music data extracting means, reproducing means, display means, operating means, voice recognizing means, and dictionary preparing means.

The operation of the audio system 1 will next be described. The audio system according to this preferred embodiment may employ one of the following two methods, in which a user provides an order for specifying a folder or file to reproduce music data by (1) using a displayed selection screen to specify a folder or a file to reproduce music, or (2) audibly specifying a folder name or a file name to reproduce music. The two methods will hereinafter be described one by one.

(1) Using a Displayed Selection Screen to Specify a Folder or a File to Reproduce Music

FIG. 4 is a flow chart illustrating an operational procedure of music reproduction using a selection screen. It should be noted that, when the USB memory 22 is connected to the audio system 1 prior to this operation, an ID (see FIG. 3) is assigned to each folder and file recorded on the USB memory 22 by the ID managing unit 18 and, referring to the ID, lower-level folders and files stored in each folder are searched for.

The selection screen preparing unit 16 first prepares and displays a selection screen including folders and files of the same level on the display unit 50 (Step 100). For example, in an initial state immediately after the USB memory 22 is connected, a selection screen including first-layer-level folders and files under the root folder 100, as shown in FIG. 2, is prepared and displayed.

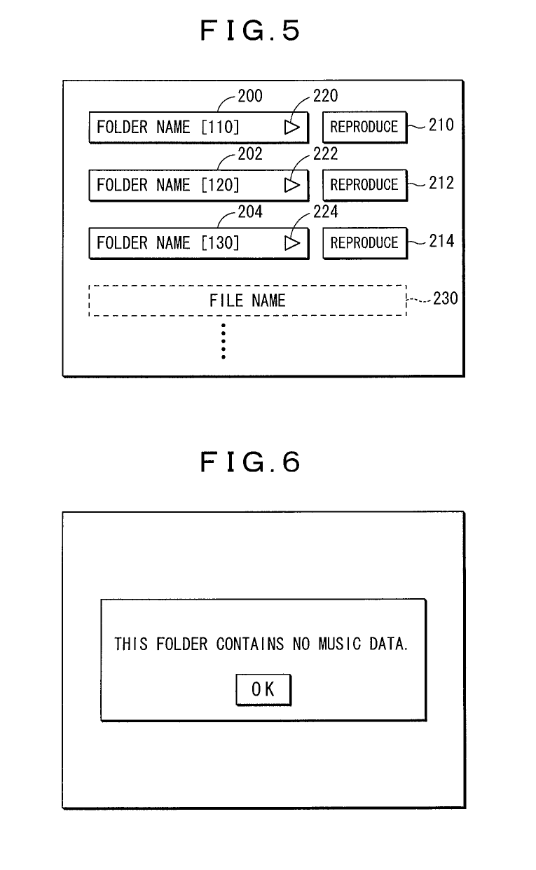

FIG. 5 illustrates a specific example of the selection screen. The selection screen includes folder name areas 200, 202, and 204 respectively including the names of the three first-layer-level folders 110, 120, and 130 shown in FIG. 2, and reproduction instruction areas 210, 212, and 214 on which to provide an instruction for searching for files included in the folders and lower-level folders thereunder to reproduce music data from each file. The folder name areas 200, 202, and 204 respectively include lower-switching instruction areas 220, 222, and 224 on which to provide an instruction for switching the display to a selection screen including the next-lower-level (second-layer-level in this case) folder/file names. The reproduction instruction areas 210, 212, and 214 each correspond to the first area, while the lower-switching instruction areas 220, 222, and 224 each correspond to the second area.

It should be noted that, although no file name is displayed on the selection screen because there exists no first-layer-level file in the example of FIG. 2, another selection screen corresponding to the second-layer-level under the folder 130, for example, would include a file name area 230 (or more areas if there are multiple files). The folder name areas 200 and the like included in the selection screen shown in FIG. 5 may be displayed only in the case where a music data file is stored in one of the folders and lower-level folders thereunder or may be displayed regardless of whether or not there is stored a file.

Next, the folder specifying unit 12 determines whether or not a user uses the operating unit 60 to provide a selective instruction (Step 102). If no selective instruction is provided on any area included in the selection screen, the determination is negative to be repeated.

On the other hand, if a selective instruction is provided on any area included in the selection screen, the determination in Step 102 is positive. Next, the folder specifying unit 12 determines whether or not there is provided an instruction for selecting a file (Step 104). The user may point his/her finger directly at the file name area 230 shown in FIG. 5 to select the file. If the file is selected, the determination in Step 104 is positive. In this case, the music data extracting unit 14 extracts music data corresponding to the selected file and the audio processing unit 40 performs music reproduction (Step 106).

If no file is selected, the determination in Step 104 is negative. Next, the folder specifying unit 12 determines whether or not a lower-level folder is selected (Step 108). The user may point his/her finger directly at the lower-switching instruction area 220 or the like to select the lower-level folder. If the lower-level folder is selected, the determination in Step 108 is positive. For example, if the user points at the lower-switching instruction area 224, the routine returns to Step 100, and a new selection screen including the three folders 13 I, 132, 133 and the file 130a stored in the folder 130 is prepared and displayed so that the routine is repeated from the determinative operation in Step 102.

If no lower-level folder is selected but the user points at any of the reproduction instruction areas 210 and the like, the determination in Step 108 is negative. In this case, the music data extracting unit 14 searches for files that are stored in the folder specified on the reproduction instruction area 210 or the like or a lower-level folder thereunder to extract music data (Step 110). For example, if the user points at the reproduction instruction area 214 shown in FIG. 5, the second-layer-level file 130a under the folder 130, three third-layer-level files 131a , 131b, and 131c stored in the folder 131, and the third-layer-level file 133a stored in the folder 133 are searched for and identified, and then music data is extracted from these files.

When one or more pieces of music data are thus extracted by the music data extracting unit 14, the audio processing unit 40 then reproduces the music data in a predetermined order (Step 112).

It should be noted that, in the case where the folder name areas 200 and the like included in the selection screen shown in FIG. 5 are displayed regardless of whether or not there is stored a music data file, even if the user points at the reproduction instruction area 210 or the like, no music data file may be stored in the corresponding folder and the lower-level folders thereunder. In this case, an error screen is displayed as shown in FIG. 6 and, when the user points at the “OK” area, the routine returns to Step 100 to be repeated from the selection screen display.

As described above, the audio system 1 according to this preferred embodiment is arranged such that when one of the folders is specified, music data stored not only in the specified folder but also in a lower-level folder under the specified folder is extracted and reproduced. This avoids the need to identify a lower-level folder to search for the music data, whereby music data stored in a hierarchical folder can be reproduced with a simpler operation, and the reproduction can be started in a shorter time. In particular, this requires only one folder to be specified to extract and reproduce all of the music data stored in the folder without performing a separate operation for the folder structure under the folder. This allows the reproducing operation to be considerably simplified.

In addition, users are only required to point at a reproduction ordering area that corresponds to a folder included in a selection screen to extract and reproduce music data stored in a lower-level folder under the selected folder without performing an additional operation, which can reduce the number of operations and thereby improve the operability.

Moreover, specifying a folder may provide an instruction for music reproduction and further switch to a selection screen including a file stored in the specified folder and/or a lower-level folder thereunder. This allows a traditional operation of specifying a folder and searching lower-level folders thereunder for music data to be performed selectively, which can improve the operability depending on a user's preference.

(2) Audibly Specifying a Folder Name or File Name to Reproduce Music

In this preferred embodiment, when the USB memory 22 is connected, a voice recognition dictionary 34 corresponding to the USB memory 22 is prepared to improve the accuracy of and reduce the time for folder name or file name identification through voice recognition.

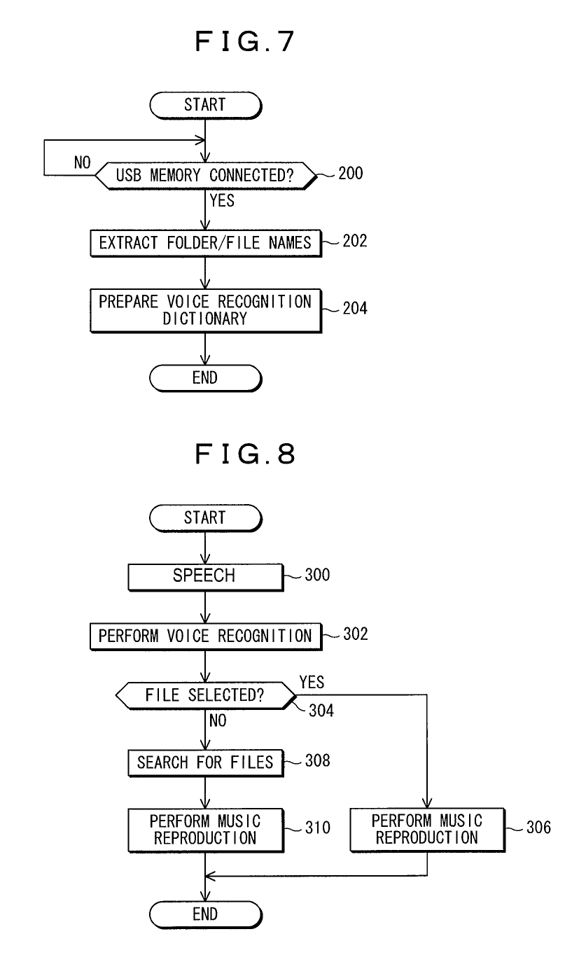

FIG. 7 is a flow chart illustrating an operational procedure of preparing the voice recognition dictionary 34. The voice recognition dictionary preparing unit 32 determines whether or not the USB memory 22 is connected (Step 200). If the USB memory 22 is not connected, the determination is negative and the step is to be repeated. However, if the USB memory 22 is connected, the determination in Step 200 is positive. Next, the voice recognition dictionary preparing unit 32 extracts the names of all folders and files recorded on the USB memory 22 (Step 202), and prepares a voice recognition dictionary used to identify these names (Step 204).

It should be noted that, since the speaker is not identified at this stage, the accuracy of voice recognition may preferably be improved by, for example, preparing both female and male voice recognition dictionaries including the names. In addition, since the process of extracting the names of the folders and files in Step 202 partially overlaps the operation of ID assignment by the ID managing unit 18 (e.g., the operation of searching for folders and/or files), the operation of ID assignment by the ID managing unit 18 may be performed after or before the operation of Step 202.

FIG. 8 is a flow chart illustrating an operational procedure of music reproduction through voice recognition. When the user speaks a folder or file name (Step 300), the voice recognizing unit 36 performs voice recognition on the speech collected by the microphone 38 to identify the folder or file name as speech content (Step 302). It should be noted that, although not only the folder or file name but also operational and/or indicative voice may be included in the speech in the actual voice recognizing operation, here will be considered the case where only the folder or file name is audibly indicated for the sake of descriptive simplicity. Unlike specifying a folder using a selection screen, the user can audibly and directly specify a folder or file name included in any hierarchical level of the folder structure shown in FIG. 2.

Next, the folder specifying unit 12 determines whether or not the corresponding music data file is selected (Step 304). If a file name is identified through voice recognition in Step 302, the determination is positive. In this case, music data corresponding to the selected file is extracted by the music data extracting unit 14 and reproduced by the audio processing unit 40 (Step 306).

On the other hand, if a folder name is identified through voice recognition in Step 302, the determination in Step 304 is negative. Thus, in the case of not file selection but folder selection, the music data extracting unit 14 then searches for files stored in the selected folder or a lower-level folder thereunder to extract music data (Step 308). For example, if the hierarchical folder 130 shown in FIG. 2 is identified, the second-layer-level file 130a under the folder 130, three third-layer-level files 131a, 131b, and 131c stored in the folder 131, and the third-layer-level file 133a stored in the folder 133 are identified, and then music data is extracted from these files.

Next, when one or more pieces of music data are thus extracted by the music data extracting unit 14, the audio processing unit 40 then reproduces the music data in a predetermined order (Step 310).

It should be noted that, if the user audibly specifies a folder with no music data stored therein, an error message saying, for example, “This folder contains no music data. Please specify another folder.” is output from the speaker 44 (this error message may be prepared by the music data extracting unit 14 or ID managing unit 18, for example), and thereafter the routine returns to Step 300 to be repeated from the user speech. Upon searching for files included in a lower-level folder in Step 308, if multiple lower-level folders exist, the user may be informed accordingly with a voice message so that one of the folders may be selected audibly.

As described above, the audio system 1 according to this preferred embodiment is arranged such that audibly specifying only a folder name allows music data stored in a lower-level folder under the specified folder to be extracted and reproduced. This can simplify an audible operation through voice recognition, if performed, and achieve significant time saving compared to the case of audibly specifying a folder in each hierarchical level to specify music data stored in a lower-level folder.

In addition, the names of folders and files recorded on the USB memory 22 are extracted and a voice recognition dictionary including these names is prepared. This allows the names of the folders and files that are to undergo voice recognition to be limited, and thus the accuracy of the voice recognition to be improved as well as the time required for the voice recognition to be reduced. In particular, a voice recognition dictionary of a size required for voice recognition is prepared each time the USB memory 22 is connected, which allows the capacity for storing the voice recognition dictionary to be reduced.

It should be noted that the present invention is not restricted to the above-described preferred embodiments and various modifications may be made without departing from the spirit and scope of the invention. Although the above-described preferred embodiments are arranged such that the series of processes is completed after music reproduction using extracted music data (Steps 106 and 112 in FIG. 4, Steps 306 and 310 in FIG. 8), the music reproduction may be repeated continuously, for example. Alternatively, after multiple files are searched for and music reproduction for multiple pieces of music data is completed, the reproduction of the music data may be continued from the initially reproduced music data, for example. This allows for continuous music reproduction with no additional operation when the audio system 1 is implemented in a car.

Although the above-described preferred embodiments describe the case where music data is recorded on the USB memory 22, the present invention may also be applied to the case where music data is recorded on, for example, a semiconductor memory such as an SD memory, a storage medium such as a CD, a DVD, or a non-removable hard disk device.

Although the above-described preferred embodiments describe the case where a selection screen including folders and/or files of one hierarchical level is displayed and a folder is selected thereon, if the display unit 50 has a large display screen, the hierarchical folder structure shown in FIG. 2 may be displayed directly as a selection screen. In this case, users may use the operating unit 60 to select any folder or file. If a folder is selected, it is only required to select a file stored in the selected folder or a lower-level folder thereunder to extract and reproduce music data, as is the case where a folder is selected audibly.

Although the above-described preferred embodiments are arranged such that one of the hierarchical folders is specified to search for files and reproduce music data, the present invention may also be applied to a play list (reproduction list) having a similarly hierarchical virtual structure. Considering, for example, the case where categories are set in the play list and thereunder artist names, their album titles, and files (music data) are set in this order, a hierarchical structure including “play list”—“category”—“artist”—“album” is formed. These hierarchical levels are virtual folders to which the present invention can be applied directly. In the example of FIG. 2, considering, for example, the case of replacing the folder 130 with a “play list”, the second-, third-, and fourth-layer level folders correspond, respectively, to categories, artists, and albums. In this case, “play list” is displayed in the folder name area 204 in the selection screen shown in FIG. 5.

Although the above-described preferred embodiments describe the audio system 1 capable of specifying a folder through a selection screen or through voice recognition, only one of the specifying methods may be employed selectively. In this case, the components required only for the unusedspecifying method may be omitted.

As described heretofore, in accordance with the embodiment, when one of the folders is specified, music data stored in a lower-level folder under the specified folder is extracted and reproduced. This avoids the need to identify a lower-level folder to search for the music data, whereby music data stored in a hierarchical folder can be reproduced with a simpler operation, and the reproduction can be started in a shorter time.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling with the scope of the appended claims.

What is claimed is:

1. A music data reproduction apparatus for reproducing music data stored in hierarchical format in one or more folders recorded on a storage medium, the apparatus comprising:
a folder specifying unit for specifying one of the folders;
a music data extracting unit for extracting music data stored in a lower-level folder under the folder that is specified by the folder specifying unit; and
an audio processing unit for reproducing the music data that is extracted by the music data extracting unit.

2. The music data reproduction apparatus according to claim 1, wherein
the music data extracting unit is configured to extract music data stored in the folder that is specified by the folder specifying unit and music data stored in a lower-level folder under the specified folder, and wherein
the audio processing unit is configured to reproduce the music data that is extracted by the music data extracting unit.

3. The music data reproduction apparatus according to claim 2, further comprising:
a display unit for displaying a selection screen including folders and files of the same level; and
an operating unit for selecting one of the folders and files of the same level included in the selection screen that is displayed on the display unit, wherein
the folder specifying unit is configured, when one of the folders is selected by the operating unit, to specify the selected folder.

4. The music data reproduction apparatus according to claim 3, wherein
the selection screen includes: a first area on which one of the displayed folders is selected and an instruction for reproducing music data stored in the selected folder and a lower-level folder thereunder is provided; and a second area on which an instruction for switching display to the selection screen that includes the music data stored in the selected folder and the lower-level folder thereunder is provided, and wherein
the display unit is configured, when the second area is selected by the operating unit, to display the selection screen that includes music data stored in the corresponding folder and a next-lower-level folder thereunder.

5. The music data reproduction apparatus according to claim 1, further comprising:
a microphone for collecting the voice of a user; and
a voice recognizing unit for recognizing the voice collected by the microphone, wherein
the folder specifying unit is configured to specify a folder based on a content identified through voice recognition by the voice recognizing unit.

6. The music data reproduction apparatus according to claim 5, wherein
when a folder name is spoken by the user, the name is identified through voice recognition by the voice recognizing unit, and
the folder specifying unit specifies a folder that corresponds to the identified name.

7. The music data reproduction apparatus according to claim 6, further comprising a voice recognition dictionary preparing unit for extracting the names of the hierarchical folders recorded on the storage medium and files representing music data stored in the folders to prepare a voice recognition dictionary including the names, wherein
the voice recognizing unit is configured to perform voice recognition using the voice recognition dictionary prepared by the voice recognition dictionary preparing unit.

8. The music data reproduction apparatus according to claim 7, wherein
the storage medium is removably connected, and wherein
the voice recognition dictionary preparing unit is configured to prepare the voice recognition dictionary when the storage medium is connected.

9. The music data reproduction apparatus according to claim 2, wherein
the audio processing unit is configured, when the reproduction of a plurality of pieces of music data is completed, to continue reproducing the music data from the initially reproduced music data.

10. A method for reproducing music data stored in hierarchical format in one or more folders recorded on a storage medium in a music data reproduction apparatus, the method comprising:
specifying one of the folders;
extracting music data stored in a lower-level folder under the folder that is specified; and
reproducing the music data that is extracted.

11. The music data reproduction method according to claim 10, wherein
music data stored in the folder that is specified and music data stored in a lower-level folder under the specified folder is extracted, and wherein
the extracted music data is reproduced.

12. The music data reproduction method according to claim 11, further comprising:
displaying on a display unit a selection screen including folders and files of the same level; and
receiving from a user an instruction selecting one of the folders and files of the same level included in the selection screen that is displayed on the display unit, wherein
when one of the folders is selected, the selected folder is specified.

13. The music data reproduction method according to claim 12, wherein
the selection screen includes: a first area on which one of the displayed folders is selected and an instruction for reproducing music data stored in the selected folder and a lower-level folder thereunder is provided; and a second area on which an instruction for switching display to the selection screen that includes the music data stored in the selected folder and the lower-level folder thereunder is provided, and wherein
when the second area is selected, the selection screen that includes music data stored in the corresponding folder and a next-lower-level folder thereunder is displayed.

14. The music data reproduction method according to claim 10, further comprising:
collecting the voice of a user using a microphone; and
recognizing the voice collected by the microphone, wherein
a folder based on a content identified through voice recognition is specified.

15. The music data reproduction method according to claim 14, wherein
when a folder name is spoken by the user, the name is identified through voice recognition, and
a folder that corresponds to the identified name is specified.

16. The music data reproduction method according to claim 15, further comprising:
extracting the names of the hierarchical folders recorded on the storage medium and files representing music data stored in the folders to prepare a voice recognition dictionary including the names, wherein
voice recognition is performed using the voice recognition dictionary.

17. The music data reproduction method according to claim 16, wherein
the storage medium is removably connected to the music data reproduction apparatus, and wherein
the voice recognition dictionary is prepared when the storage medium is connected.

18. The music data reproduction method according to claim 11, wherein
when the reproduction of a plurality of pieces of music data is completed, reproducing the music data is continued from the initially reproduced music data.
